(19) United States
(12) Patent Application Publication
(10) Pub. No.: US 2009/0154568 A1
(43) Pub. Date: Jun. 18, 2009

(54) MULTIMEDIA DECODING APPARATUS AND METHOD

(75) Inventors: Yu-Ting Chuang, Kaohsiung Hsien (TW); Chi-Wang Chai, San Jose, CA (US)

Correspondence Address: LADAS & PARRY, 5670 WILSHIRE BOULEVARD, SUITE 2100, LOS ANGELES, CA, 90036-5679, US

(73) Assignee: REALTEK SEMICONDUCTOR CORP., Hsinchu (TW)

(21) Appl. No.: 11/954,720

(22) Filed: Dec. 12, 2007

(51) Int. Cl. H04N 7/12

(52) U.S. Cl. 375/240.25; 375/E07.027

(57) ABSTRACT

A multimedia decoding apparatus and method thereof can accelerate decoding speed. The multimedia decoding apparatus is adapted for decoding a multimedia packet that includes a header portion and a data portion. The multimedia decoding apparatus includes a header parsing module, a storage unit, and a data processing module. The header parsing module receives the multimedia packet and parses the header portion of the multimedia packet to output at least one parameter. The storage unit is coupled to the header parsing module for storing the parameter and the data portion of the multimedia packet. The data processing module is coupled to the storage unit for processing the data portion of the multimedia packet according to the parameter. When the data processing module processes the data portion of the multimedia packet, the header parsing module parses the header portion of another multimedia packet simultaneously.

### BACKGROUND OF THE INVENTION

1. Field of the Invention

The invention relates to a multimedia decoding apparatus and method, more particularly to a multimedia decoding apparatus and method that can accelerate decoding speed.

2. Description of the Related Art

With the continued advancement in imaging techniques, sizes of images tend to become larger, resulting in a larger bandwidth requirement for transmitting image bit streams. To reduce the bandwidth required when transmitting image bit streams, many complicated image compression algorithms, such as MPEG1, MPEG2, H.264, etc., have been developed to increase the image compression rate while maintaining high quality image information. Accordingly, techniques for accelerating encoding or decoding have been proposed.

For current image decoding circuits, a high-speed data path is usually employed for computations to increase circuit efficiency. However, use of a high-speed data path for increasing the circuit efficiency complicates the circuit design.

### SUMMARY OF THE INVENTION

Therefore, one object of the present invention is to provide a multimedia decoding apparatus that can accelerate decoding speed.

According to one aspect of the present invention, there is provided a multimedia decoding apparatus adapted for decoding a multimedia packet that includes a header portion and a data portion. The multimedia decoding apparatus comprises a header parsing module, a storage unit, and a data processing module. The header parsing module receives the multimedia packet and parses the header portion of the multimedia packet to output at least one parameter. The storage unit is coupled to the header parsing module for storing the at least one parameter and the data portion of the multimedia packet. The data processing module is coupled to the storage unit for processing the data portion of the multimedia packet according to the at least one parameter. When the data processing module processes the data portion of the multimedia packet, the header parsing module parses the header portion of another multimedia packet simultaneously.

Another object of the present invention is to provide a multimedia decoding method that can accelerate decoding speed.

According to another aspect of the present invention, there is provided a multimedia decoding method adapted for decoding a multimedia packet that includes a header portion and a data portion. The multimedia decoding method comprises the steps of: receiving the multimedia packet and parsing the header portion of the multimedia packet to output at least one parameter; storing the at least one parameter and the data portion of the multimedia packet in a storage unit; and processing the data portion of the multimedia packet according to the at least one parameter in the storage unit; wherein, when the data portion of the multimedia packet is being processed, the header portion of another multimedia packet is parsed simultaneously.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a multimedia decoding apparatus according to the present invention; and

FIG. 2 is a timing diagram to illustrate a decoding operation of the preferred embodiment.

### DETAILED DESCRIPTION OF THE PREFERRED EMBODIMENT

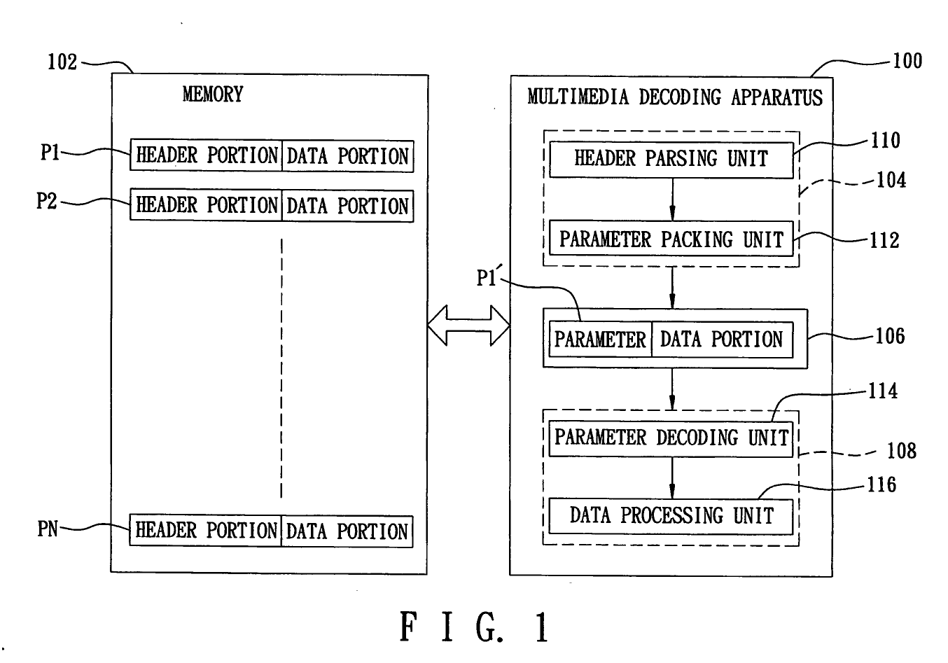

Referring to FIG. 1, the preferred embodiment of a multimedia decoding apparatus 100 according to the present invention is applied to a multimedia device. The multimedia decoding apparatus 100 includes a header parsing module 104, a storage unit 106 coupled to the header parsing module 104, and a data processing module 108 coupled to the storage unit 106. The multimedia decoding apparatus 100 is adapted for decoding multimedia packets (P1˜PN) in a memory 102. The multimedia packets (P1˜PN) belong to a portion of a video stream received from the Internet or other transmitting media, and each multimedia packet (P1˜PN) includes a header portion and a data portion.

In operation, the multimedia decoding apparatus 100 reads a multimedia packet (P1) from the memory 102, and parses the header portion of the multimedia packet (P1) through a header parsing unit 110 of the header parsing module 104. In this embodiment, the header parsing unit 110 parses the header portion of the multimedia packet (P1) to output a plurality of parsed parameters, such as a motion vector parameter, a boundary strength parameter, a weighting parameter, etc. Thereafter, the parsed parameters are packed or encoded through a parameter packing unit 112 of the header parsing module 104. The packed parameters are subsequently outputted for storage in the storage unit 106. In addition, the header parsing module 104 further stores the data portion of the multimedia packet (P1) in the storage unit 106. After the packed parameters and the data portion of the multimedia packet (P1) are stored in storage unit 106, the data processing module 108 retrieves a parsed multimedia packet (P1′), which includes a parameter portion and a data portion, from the storage unit 106 for decoding. In this embodiment, the data processing module 108 includes a parameter decoding unit 114 and a data processing unit 116 coupled to the parameter decoding unit 114. The data processing unit 116 is a decoding circuit used for performing decoding according to decoded parameters outputted from the parameter decoding unit 114. As an example, the parameter decoding unit 114 performs parameter decoding upon the parameter portion of the parsed multimedia packet (P1′) to output a motion vector to the data processing unit 116. Thereafter, the data processing unit 116 performs motion compensation computations according to the motion vector for accomplishing the decoding operation, and the decoded data are subsequently stored in the memory 102. It is noted that, since the storage unit 106 of the multimedia decoding apparatus 100 is a pipeline register, when the data processing module 108 processes the parsed multimedia packet (P1′), the header parsing module 104 can parse the header portion of another multimedia packet, such as the header portion of a multimedia packet (P2), simultaneously to achieve the effect of accelerating the decoding speed.

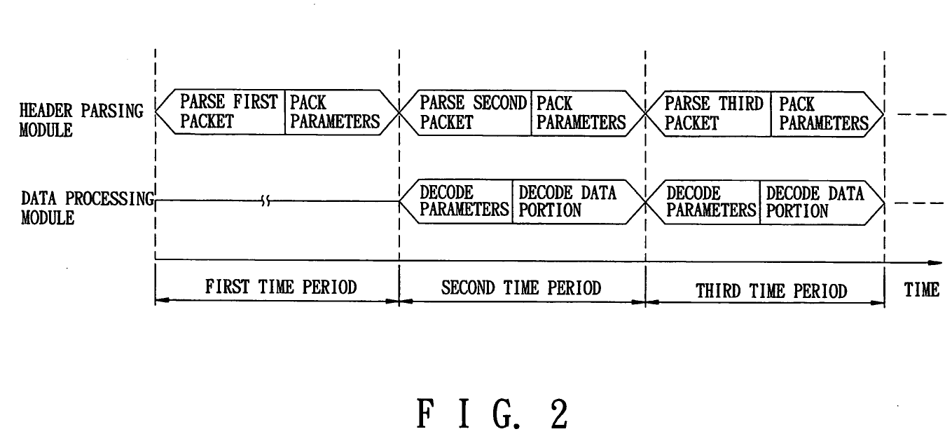

FIG. 2 is a timing diagram to illustrate operation of the multimedia decoding apparatus 100 of the preferred embodiment. During a first time period, the header parsing module 104 parses the header portion of the multimedia packet (P1) and packs parsed parameters, and then stores the packed parameters and the data portion of the multimedia packet (P1) in the storage unit 106. Next, during a second time period, the header parsing module 104 and the data processing module 108 operate simultaneously. In particular, the header parsing module 104 parses the header portion of the succeeding multimedia packet (P2), while the data processing module 108 processes the parsed multimedia packet (P1′). As in the foregoing, the parameter portion of the parsed multimedia packet (P1′) is decoded through the parameter decoding unit 114 of the data processing module 108, and the data portion of the parsed multimedia packet (P1′) is decoded through the data processing unit 116 of the data processing module 108 according to the decoded parameters from the parameter decoding unit 114. In the same manner, during a third time period, the header parsing module 104 and the data processing module 108 operate simultaneously to achieve the effect of accelerating the decoding speed. It is apparent from the foregoing that the multimedia decoding apparatus 100 of this invention includes a storage unit 106 for pipelining the header portions and the data portions to achieve the effect of accelerating the decoding speed. Moreover, through the parameter packing unit 112 in the header parsing module 104 and the parameter decoding unit 114 in the data processing module 108, the effect of reducing the required size of the storage unit 106 can be achieved.

In this embodiment, the header parsing module 104 and the data processing module 108 of the multimedia decoding apparatus 100 are realized using a reduced instruction set computer (RISC) microprocessor and a hardware accelerator, respectively. Moreover, in addition to motion compensation, the data processing module 108 can be configured to perform other computations, such as entropy decoding, inverse quantization, inverse transformation, etc. Furthermore, the multimedia decoding apparatus 100 of this invention can be applied to any encoding/decoding application of multimedia and audio-visual data, such as MPEG1, MPEG2, MPEG7, MPEG21, H.264, etc.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A multimedia decoding apparatus adapted for decoding a multimedia packet that includes a header portion and a data portion, said multimedia decoding apparatus comprising:
a header parsing module for receiving the multimedia packet and for parsing the header portion of the multimedia packet to output at least one parameter;
a storage unit coupled to said header parsing module for storing said at least one parameter and the data portion of the multimedia packet; and
a data processing module coupled to said storage unit for processing the data portion of the multimedia packet according to said at least one parameter;
wherein, when said data processing module processes the data portion of the multimedia packet, said header parsing module parses the header portion of another multimedia packet simultaneously.

2. The multimedia decoding apparatus as claimed in claim 1, wherein said header parsing module comprises:
a header parsing unit for parsing the header portion of the multimedia packet to output a plurality of parsed parameters; and
a parameter packing unit coupled to said header parsing unit for packing the parsed parameters for subsequent output as said at least one parameter.

3. The multimedia decoding apparatus as claimed in claim 2, wherein said data processing module comprises:
a parameter decoding unit for decoding said at least one parameter to output a plurality of decoded parameters; and
a data processing unit coupled to said parameter decoding unit for processing the data portion of the multimedia packet according to the decoded parameters.

4. The multimedia decoding apparatus as claimed in claim 3, wherein said data processing unit decodes the data portion of the multimedia packet according to the decoded parameters.

5. The multimedia decoding apparatus as claimed in claim 1, wherein said header parsing module is implemented by a reduced instruction set computer (RISC) microprocessor.

6. The multimedia decoding apparatus as claimed in claim 1, wherein said data processing module is a hardware accelerator.

7. The multimedia decoding apparatus as claimed in claim 1, wherein said storage unit is a pipeline register.

8. The multimedia decoding apparatus as claimed in claim 1, wherein said at least one parameter includes a motion vector.

9. The multimedia decoding apparatus as claimed in claim 1, wherein said data processing module performs motion compensation computations according to said at least one parameter.

10. The multimedia decoding apparatus as claimed in claim 1, wherein said multimedia decoding apparatus is a H.264 multimedia decoding apparatus.

11. A multimedia decoding method adapted for decoding a multimedia packet that includes a header portion and a data portion, said multimedia decoding method comprising the steps of:
receiving the multimedia packet and parsing the header portion of the multimedia packet to output at least one parameter;
storing said at least one parameter and the data portion of the multimedia packet in a storage unit; and
processing the data portion of the multimedia packet according to said at least one parameter in the storage unit;
wherein, when the data portion of the multimedia packet is being processed, the header portion of another multimedia packet is parsed simultaneously.

12. The multimedia decoding method as claimed in claim 11, wherein the step of parsing the header portion of the multimedia packet to output said at least one parameter further comprises:
parsing the header portion of the multimedia packet to output a plurality of parsed parameters; and
packing the parsed parameters for subsequent output as said at least one parameter.

13. The multimedia decoding method as claimed in claim 12, wherein the step of processing the data portion of the multimedia packet according to said at least one parameter in the storage unit further comprise:
decoding said at least one parameter to output a plurality of decoded parameters; and
processing the data portion of the multimedia packet according to the decoded parameters.

14. The multimedia decoding method as claimed in claim 13, wherein, in the step of processing the data portion of the multimedia packet according to the decoded parameters, the data portion of the multimedia packet is decoded according to the decoded parameters.

15. The multimedia decoding method as claimed in claim 11, wherein the step of parsing the header portion of the multimedia packet to output said at least one parameter is implemented by a reduced instruction set computer (RISC) microprocessor.

16. The multimedia decoding method as claimed in claim 11, wherein the step of processing the data portion of the multimedia packet according to said at least one parameter in the storage unit is implemented by a hardware accelerator.

17. The multimedia decoding method as claimed in claim 11, wherein the storage unit is a pipeline register.

18. The multimedia decoding method as claimed in claim 11, wherein said at least one parameter includes a motion vector.

19. The multimedia decoding method as claimed in claim 13, wherein, in the step of processing the data portion of the multimedia packet according to the decoded parameters, motion compensation computations for the data portion of the multimedia packet are performed according to the decoded parameters.

20. The multimedia decoding method as claimed in claim 11, wherein the multimedia decoding method is adapted to be implemented by a H.264 multimedia decoding apparatus.
